(19) United States
(12) Patent Application Publication
(10) Pub. No.: US 2021/0022951 A1
(43) Pub. Date: Jan. 28, 2021

(54) HANDHELD MUSCLE MASSAGER

(71) Applicant: DONGGUAN XIQIN Electrical Appliance Co., Ltd., DONGGUAN (CN)

(72) Inventor: Dashuai HU, Dongguan (CN)

(21) Appl. No.: 17/042,782

(22) PCT Filed: May 15, 2019
(86) PCT No.: PCT/CN2019/086962

§ 371 Date: Sep. 28, 2020

(30) Foreign Application Priority Data
Jan. 18, 2019 (CN) 201910056372.9

(51) Int. Cl. A61H 9/00

(52) U.S. Cl. CPC A61H 9/0021; A61H 2201/1418; A61H 2201/1246; A61H 2201/0153

(57) ABSTRACT

A hand-held muscle massager, comprising a massage body (10), a massage head (20), a main handle (30) and an auxiliary handle (40), wherein the main handle (30) and the auxiliary handle (40) are simultaneously connected to a handle connecting end (12), the hand-held muscle massager further comprising a driving motor (110), a piston-type moving head (120) and a connecting rod assembly (130), the massage body (10) has a body inner cavity (61) which is provided with a motion opening (62), the main handle (30) is provided with a main handle inner cavity (63), and the auxiliary handle (40) is provided with a auxiliary handle inner cavity (64), the body inner cavity (61), the main handle inner cavity (63) and the auxiliary handle inner cavity (64) are communicated with each other to form a ventilation and heat dissipation passage.

### FIELD OF THE INVENTION

The present invention relates to a massager, in particular to a massager with a unique holding method and a novel heat dissipation structure.

### PRIOR ART

The massager is a new generation of health massage equipment developed according to physics, bionics, bioelectricity, medicine and many years of clinical practice. Using several independent soft touch massage heads, the massager can relax muscles, relieve nerves, promote blood circulation, strengthen cell metabolism and enhance skin elasticity. At the same time, the massager can also relieve fatigue, relieve various chronic pain, acute pain and muscle soreness, relax the body, relieve pressure and reduce skin wrinkles. Especially after people finish the high-intensity muscle training, massage through the massager can greatly relieve the muscle soreness and repair the muscle injury.

Among many massager products, the handheld massager is the most widely used, The massager is used to massage muscles after high-intensity muscle training. As shown in FIGS. 1-2, there are two typical hand-held massagers.

The hand-held massager shown in FIG. 1 mainly includes a body 1 and a handle 2, a massage head 3 is provided at the front end of the body 1, motors, batteries and other components are assembled in the body 1. The user holds the handle 2 and presses the massage head 3 against the human body to perform massage. The handheld massager shown in FIG. 1 still has many disadvantages as follows. First, because the user only can hold the handle 2 by one hand to do massage, so there must be insufficient holding and pressing force, which will affect the massage effect. Secondly, in this type of massager, the main components are concentrated in the body 1 which has no related heat dissipation structure, so the product will often overheat when used for a long time, which will affect the product life and use experience.

FIG. 2 shows a simple hand-held massager, the handle 4 of which is connected to the massage body 5 to form an integral structure. It also has the above-mentioned disadvantages of insufficient holding and pressing force, poor massage effect, and unsatisfactory heat dissipation.

It is worth emphasizing here that in order to overcome the shortcomings of poor heat dissipation of the massager, the traditional hand-held massager is provided with heat dissipation holes in its body and grip for ventilation and heat dissipation, but in practice most fitness people will massage the muscle groups by massager after strenuous exercise. At this time, a large amount of sweat will remain on the user's body surface and palm area. The user's sweat often enters the massager through the heat dissipation holes, which will contaminate the electronic components such as motors, coils, control boards, etc., and then results in short circuit, burnout and other failures, and there are hidden safety risks.

### SUMMARY OF THE INVENTION

The present invention provides a hand-held muscle massager, includes a body, a massage head and a driving rod, the body has an inner cavity and an opening which is communicated and disposed at one end of the inner cavity, a heat dissipation channel is formed at the opening, the heat dissipation hole is arranged at the front end of the massager, which can prevent sweat from entering the massager through the heat dissipation hole and contaminate the electronic components such as the motor, coil, and control board inside the massager, and can avoid short circuit, burnout and other failures, and eliminate potential safety hazards. It is main object of the invention.

The invention provides a hand-held muscle massager, including a massage body, a massage head, a main handle and an auxiliary handle, the massage body, the main handle and the auxiliary handle are connected to form an integral body. A smooth pressing grip surface is formed at the joint of the massage body, the main handle and the auxiliary handle, and a user can hold the smooth pressing grip surface to perform pressing massage. The invention avoids the structural design of the rear boss of the traditional massager through the design concept of the smooth pressing holding surface. The massager can make the palm of the user press on the back of the massager comfortably, which can enhance the feeling of use, facilitate the user to exert force and enhance the massage effect. It is another object of the invention.

The technical scheme adopted in the invention is: a hand-held muscle massager, comprising a massage body, a massage head, a main handle and an auxiliary handle, wherein the massage body is provided with a massage head assembling end and a handle connecting end, the massage head is assembled in the massage head assembling end, while the main handle and the auxiliary handle are simultaneously connected to the handle connecting end, the massage body, the main handle and the auxiliary handle are connected to form an integral body, a smooth pressing grip surface is formed at the joint of the massage body, the main handle and the auxiliary handle, and a user can hold the smooth pressing grip surface to perform pressing massage.

A hand-held muscle massager comprising a body, a massage head and a driving rod, wherein, the body has an inner cavity and an opening which is communicated and disposed at one end of the inner cavity, the driving rod is disposed in the inner cavity, the massage head is connected to the end of the driving rod, while the massage head is located in the opening, the driving rod reciprocates and drives the massage head to reciprocate in the opening, thus a heat dissipation channel is formed at the opening ,the external air of the body is sucked into the inner cavity from the heat dissipation channel by the reciprocating of the driving rod, and then discharged from the channel by the reciprocating of the driving rod.

The beneficial effects of the invention are as follows: during use, the user holds the main handle and the auxiliary handle with both hands and presses the massage head against the human body to perform a massage. The user can also hold the main handle or the auxiliary handle with one hand to massage. The user can grip the smooth pressing grip surface to perform a downward pressure massage, and the user can also press on the smooth pressing grip surface with one hand to perform a downward massage. The present invention can avoid the design of rear convex platform of the rear end of the traditional massager through the smooth pressing grip surface, which can enable the user's palm press comfortably on the rear of the massager, thus can improve the use experience and is convenient for the user to apply force, and enhance the massage effect.

In addition, by the reciprocating of the piston-type moving head, external air is drawn into the ventilation and heat dissipation passage from the motion opening and pumped out by the reciprocating of the piston-type moving head after absorbing heat in the passage to achieve the function of dissipating heat for each component in the ventilation and heat dissipation passage.

In addition, a self-adaptive adjustment gap is provided at the connection position of the connecting rod assembly and the piston-type moving head. When the driving motor drives the piston-type moving head to move by the connecting rod assembly, first, the driving motor drives the connecting rod assembly to move, and at the same time, the connecting rod assembly drives the moving head to move, at this moment, the self-adaptive adjustment gap is adjusted by the driving force of the connecting rod assembly acted on the moving head, so that the connecting rod assembly and the piston-type moving head can naturally adjust the connection position relationship with the help of the driving force, so that the overall transmission relationship is smoother, and the occurrence of jamming, hard friction and heat generation are avoided.

### BRIEF DESCRIPTION OF THE DRAWINGS

FIGS. 1 to 2 are schematic diagrams of the traditional massagers.

FIG. 3 is a perspective view of the present invention

FIG. 4 is a schematic view of the use state of the present invention

FIG. 5 is a schematic diagram of heat dissipation of the first way of ventilation and heat dissipation passage of the present invention.

FIG. 6 is a schematic diagram of heat dissipation of the second way of ventilation and heat dissipation passage of the present invention.

FIG. 7 is a sectional view of the driving motor, piston-type moving head and connecting rod assembly of the present invention.

FIG. 8 is a top view of the drive motor, piston-type moving head and connecting rod assembly of the present invention.

FIG. 9 is a exploded perspective view of the present invention.

FIG. 10 is a schematic diagram of the detachable connection unit of the present invention.

FIG. 11 is a schematic diagram of the working principle of the heat dissipation channel of the present invention.

FIGS. 12 to 14 are schematic diagrams of the position of an embodiment of the heat dissipation channel of the present invention.

FIG. 15 is a schematic view of the driving rod and sleeve of the present invention.

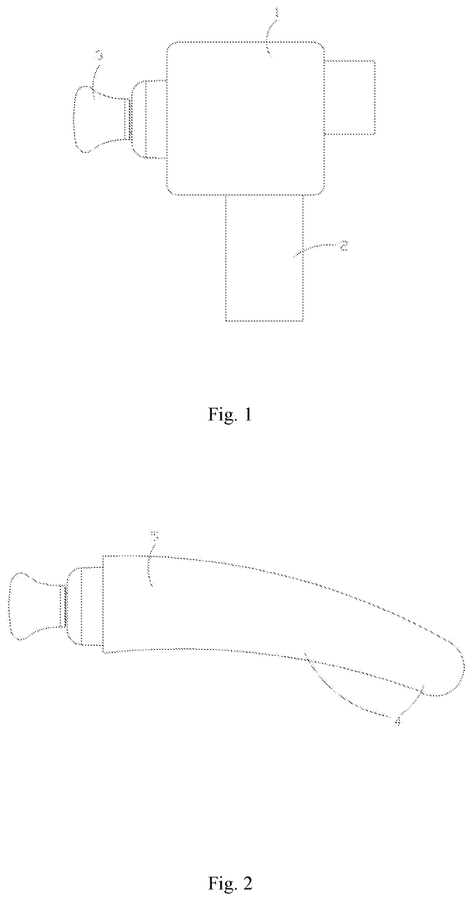

### DETAILED DESCRIPTION OF THE INVENTION

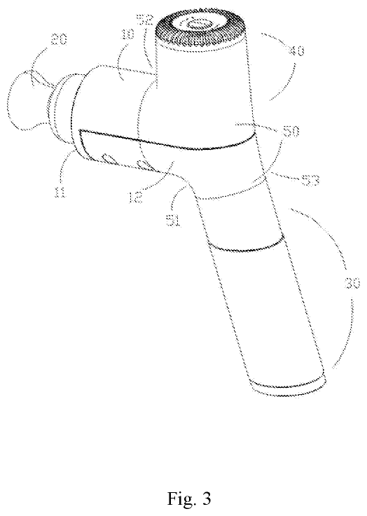

As shown in FIGS. 3 to 10, a hand-held muscle massager includes a massage body 10, a massage head 20, a main handle 30 and an auxiliary handle 40.

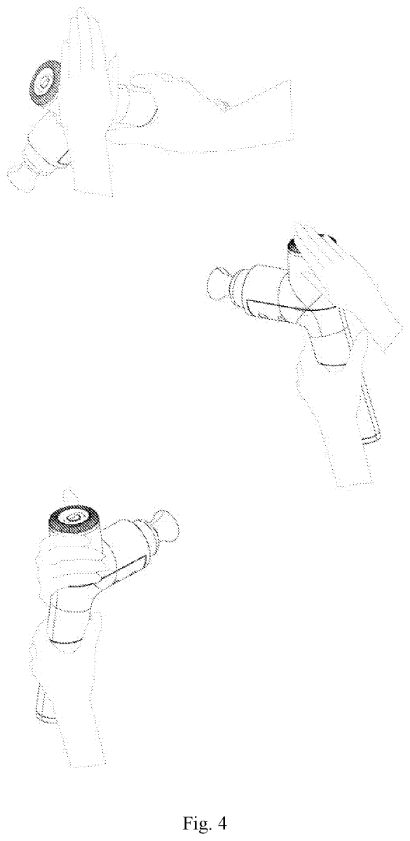

As shown in FIGS. 3 to 4, the massage body 10 includes a massage head assembling end 11 and a handle connecting end 12.

In specific implementation, the massage head assembling end 11 and the handle connecting end 12 are located at the front and rear ends of the massage body 10 respectively.

The massage head 20 is assembled in the massage head assembling end 11.

The main handle 30 and the auxiliary handle 40 are simultaneously connected to the handle connecting end 12, and the massage body 10, the main handle 30 and the auxiliary handle 40 are connected to form an integral structure.

As shown in FIG. 4, during use, the user holds the main handle 30 and the auxiliary handle 40 with both hands and presses the massage head 20 against the human body to perform a massage. The user can also hold the main handle 30 or the auxiliary handle 40 with one hand to massage.

A smooth pressing grip surface 50 is formed at the intersection of the massage body 10, the main handle 30 and the auxiliary handle 40. The user can grip the smooth pressing grip surface 50 to perform a downward pressure massage, and the user can also press on the smooth pressing grip surface 50 with one hand to perform a downward massage.

The present invention can avoid the design of rear convex platform of the rear end of the traditional massager through the smooth pressing grip surface 50, which can enable the user's palm press comfortably on the rear of the massager, thus can improve the use experience and is convenient for the user to apply force, and enhance the massage effect.

A main angle 51 is formed between the massage body 10 and the main handle 30, and a auxiliary angle 52 is formed between the massage body 10 and the auxiliary handle 40. A handle angle 53 is formed between the main handle 30 and the auxiliary handle 40.

In practice, the overall structure of the product can be specifically defined by changing the three angles said above. A preferred embodiment is described as follows.

The main angle 51 is greater than 90° and less than or equal to 135°, the auxiliary angle 52 is 90°, and the handle angle 53 is greater than 135° and less than or equal to 180°.

In specific implementation, the angle 53 of the handle is equal to 180°, and the smooth pressing grip surface 50 is an upright surface, for example, it may be the outer surface of a cylinder.

As shown in FIGS. 3 to 9, the hand-held muscle massager further includes a driving motor 110, a piston-type moving head 120 and a connecting rod assembly 130. The massage body 10 has an inner cavity 61 which is provided with a motion opening 62, the main handle 30 includes a main handle inner cavity 63, and the auxiliary 40 has a auxiliary handle inner cavity 64.

The inner cavity 61, the main handle inner cavity 63 and the auxiliary handle inner cavity 64 communicate with each other to form a ventilation and heat dissipation passage.

The driving motor 110, the piston-type moving head 120 and the connecting rod assembly 130 are simultaneously disposed in the ventilation and heat dissipation passage.

The massage head 20 is assembled on the piston-type moving head 120 located in the motion opening 62.

The connecting rod assembly 130 is connected between the driving motor 110 and the piston-type moving head 120. The driving motor 110 drives the piston-type moving head 120 to reciprocate at high speed in the motion opening 62 through the connecting rod assembly 130.

By the reciprocating of the piston-type moving head 120, external air is drawn into the ventilation and heat dissipation passage from the motion opening 62 and pumped out by the reciprocating of the piston-type moving head 120 after absorbing heat in the passage to achieve the function of dissipating heat for each component in the ventilation and heat dissipation passage.

During specific implementation, the hand-held muscle massager further includes a battery assembly 140, and the battery assembly 140 is also disposed in the ventilation and heat dissipation passage.

In the specific implementation, the driving motor 110 may be disposed in the inner cavity 63 of the main handle or the inner cavity 64 of the auxiliary handle. The battery assembly 140 may also be provided in the inner cavity 63 or the inner cavity 64. The piston-type moving head 120 and the connecting rod assembly 130 are disposed in the inner cavity 61.

In the specific implementation, the ventilation and heat dissipation passage can be used for ventilation and heat dissipation in the following specific ways.

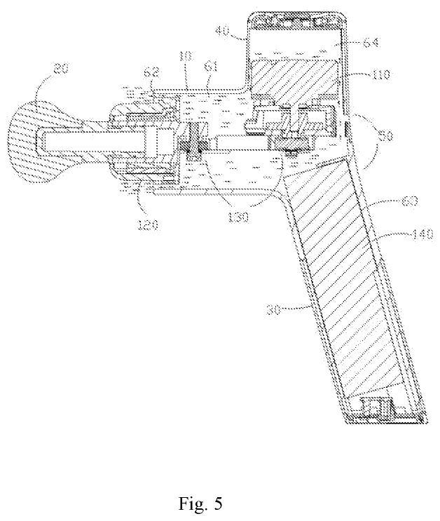

As shown in FIG. 5, in the first way, the motion opening 62 is both the air inlet and the air outlet of the ventilation and heat dissipation passage, and the external air is drawn into the passage from the motion opening 62 by means of the reciprocating of the piston-type moving head 120 and pumped out from the motion opening 62 after absorbing heat in the passage to achieve heat dissipation for each component provided in the ventilation heat dissipation passage.

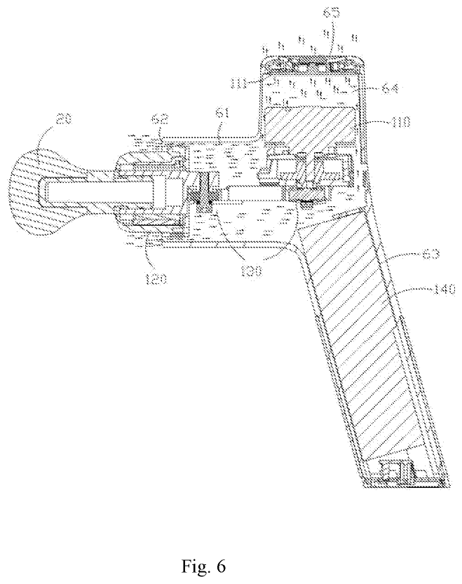

As shown in FIG. 6, in the second way, the motion opening 62 is an air inlet of the ventilation and heat dissipation passage, and the passage includes an air outlet 65 which is provided on the main handle 30 or the auxiliary handle 40.

The external air is drawn into the ventilation and heat dissipation passage from the motion opening 62 by means of the reciprocating of the piston-type moving head 120 and pumped out from the air outlet 65 after absorbing heat in the passage to achieve heat dissipation for each component provided in the passage.

In a specific implementation, the air outlet 65 is provided on the top of the auxiliary handle 40, and the driving motor 110 is disposed in the inner cavity 64 of the auxiliary handle, so that the ventilation and heat dissipation passage mainly dissipates heat for the driving motor 110.

At the same time, the main circuit board 111 is also disposed in the inner cavity 64 of the auxiliary handle 40. In a preferred embodiment, the main circuit board 111 is disposed above the driving motor 110 and fixedly connected below the air outlet 65.

In the third way, the motion opening 62 is an air inlet of the ventilation and heat dissipation passage which includes an air outlet 65. The air outlet 65 is arranged on the main handle 30 and the auxiliary handle 40.

The external air is drawn into the ventilation and heat dissipation passage from the motion opening 62 by means of the reciprocating of the piston-type moving head 120 and pumped out from the air outlet 65 after absorbing heat in the passage to achieve heat dissipation for each component provided in the passage.

In a preferred embodiment, the air outlet 65 is provided on the top of the auxiliary handle 40, and at the same time, the air outlet 65 is also provided on the side of the main handle 30.

The air outlet 65 can also be provided at the top of the auxiliary handle 40, and at the same time, the air outlet 65 may be provided at the bottom end of the main handle 30.

The air outlet 65 may also be provided on the sides of the main handle 30 and the auxiliary handle 40 at the same time.

In the three ways said above, the driving motor 110 and the battery assembly 140 may be respectively disposed in the main handle 30 and the auxiliary handle 40, and may also be simultaneously disposed in the main grip handle 30 or the auxiliary handle 40.

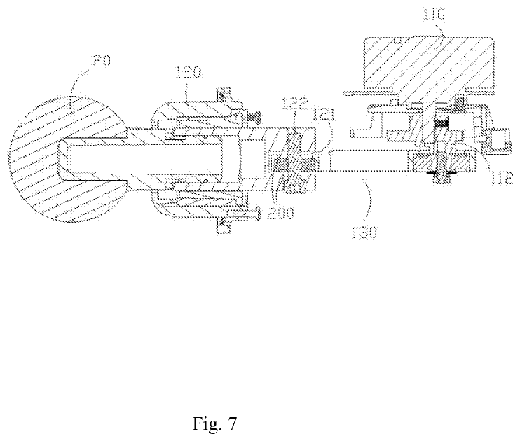

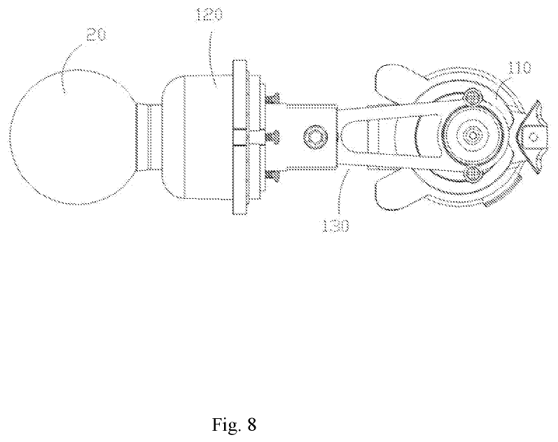

As shown in FIGS. 7 to 8, in a specific implementation, the connecting rod assembly 130 is connected between the driving motor 110 and the piston-type moving head 120, and the driving motor 110 drives the moving head 120 to reciprocates at high speed in the motion opening 62 by the connecting rod assembly 130.

A self-adaptive adjustment gap 200 is provided at the connection position of the connecting rod assembly 130 and the piston-type moving head 120.

When the driving motor 110 drives the piston-type moving head 120 to move by the connecting rod assembly 130, first, the driving motor 110 drives the connecting rod assembly 130 to move, and at the same time, the connecting rod assembly 130 drives the moving head 120 to move, at this moment, the self-adaptive adjustment gap 200 is adjusted by the driving force of the connecting rod assembly 130 acted on the moving head 120, so that the connecting rod assembly 130 and the piston-type moving head 120 can naturally adjust the connection position relationship with the help of the driving force, so that the overall transmission relationship is smoother, and the occurrence of jamming, hard friction and heat generation are avoided.

In practice, if the self-adaptive adjustment gap 200 does not exist, the connecting rod assembly 130 and the piston-type moving head 120 must be fixedly locked. At this moment, if there is a slight assembly error during assembly, there will inevitably be a hard friction caused by the uneven transmission relationship, which will produce a great amount of working noise and affect the use experience and greatly reduce the product life.

In specific implementation, a cam 112 is sleeved on the output shaft of the driving motor 110, the connecting rod assembly 130 is a rigid connecting rod, one end of the rigid connecting rod is fixedly locked on the cam 112, and the other end is pivoted in the piston-type moving head 120. The self-adaptive adjustment gap 200 is location at a position where the rigid connecting rod is pivotally connected to the piston-type moving head 120.

In practice, one end of the piston-type moving head 120 is provided with a pivoting groove 121. The rigid connecting rod is inserted into the pivoting groove 121. The pivot bolt 122 pivotally connects the rigid connecting rod to the pivoting groove 121.

The self-adaptive adjustment gap 200 is simultaneously located between the top surface of the rigid connecting rod and the top surface of the pivot groove 121, at the same time, located between the bottom surface of the rigid connecting rod and bottom surface of the pivot groove 121.

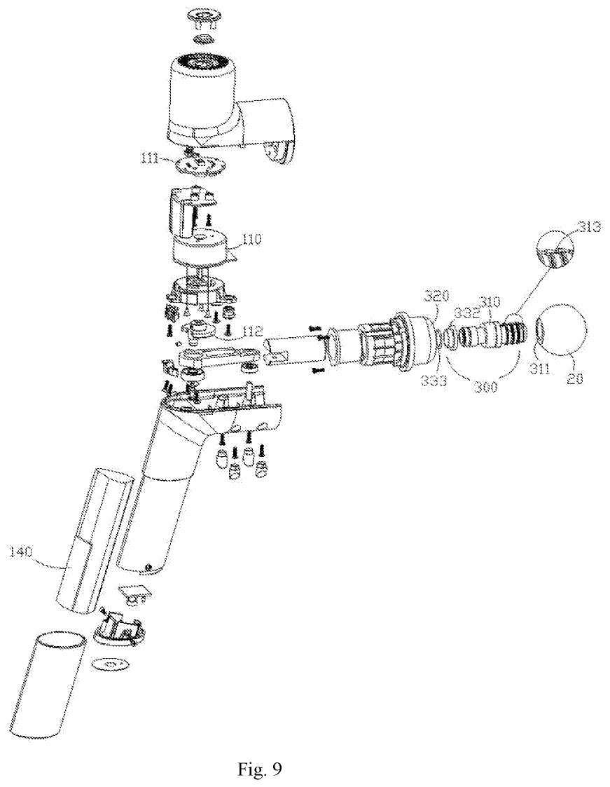

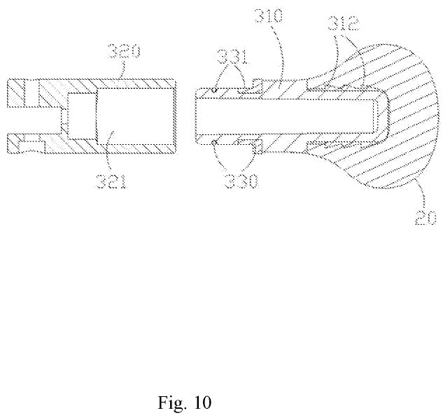

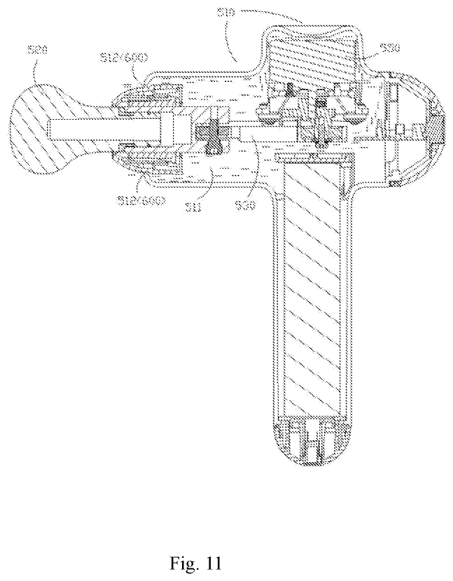

As shown in FIGS. 9 to 10, in specific implementation, the massage head 20 is assembled on the piston-type moving head 120 through a detachable connection unit 300.

In practice, the massage head 20 can be a massage head of various shapes.

The detachable connection unit 300 includes a plug 310, and the massage head 20 is detachably mounted on the plug 310, wherein the massage head 20 has a detachable groove 311. A plurality of snap rings 312 are provided on the plug 310.

When the plug 310 is inserted into the detachable groove 311, the longitudinal relative positions of the massage head 20 and the plug 310 are fixed by the snap rings 312, so that the massage head 20 may not easily fall off from the plug 310.

Along the longitudinal direction of the plug 310, a positioning groove 313 is recessed on the outer surface of the plug 310, through which the lateral relative position of the massage head 20 and the plug 310 can be fixed, so that the massage head 20 will not rotate on the plug 310, thus improves the use experience.

The detachable connection unit 300 further includes a connection front nozzle 320 which the plug 310 is inserted into. The connection front nozzle 320 is provided with an insertion hole 321, so that the plug 310 can be inserted into the insertion hole 321.

A connecting sleeve assembly 330 is sleeved on the plug 310 which is located between the plug 310 and the insertion hole 321.

The insertion hole 321 has a smooth face inner wall, and the connecting sleeve assembly 330 corresponding to the smooth face inner wall has a smooth outer connection face 331.

The smooth outer connection surface 331 and the smooth face inner wall are bonded together to form a vacuum connection, so as to improve the stability of insertion of the plug 310 in the connection front nozzle 320.

In a specific implementation, the connecting sleeve assembly 330 includes a connecting sleeve 332 and a connecting ring 333. The outer surfaces of the connecting sleeve 332 and the connecting ring 333 constitute the smooth outer connecting surface 331.

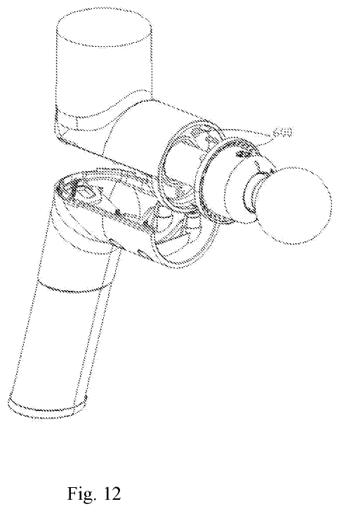

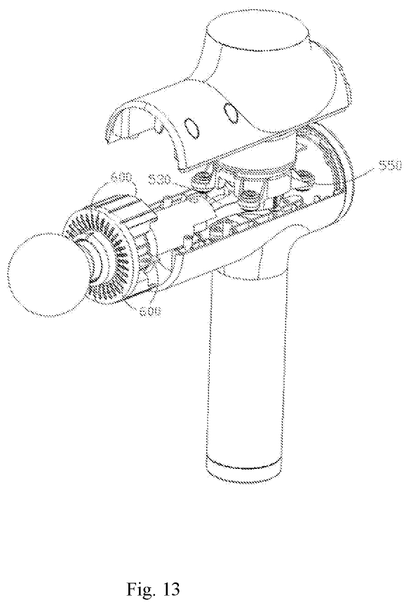

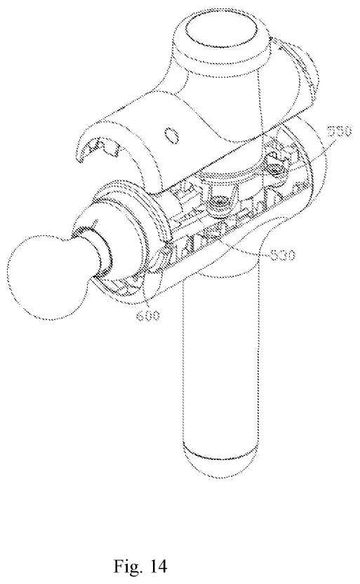

As shown in FIGS. 11 to 15, a hand-held muscle massager includes a massage body 510, a massage head 520 and a driving rod 530, wherein the massage body 510 has an inner cavity 511 and an opening 512 which is communicated with one end of the inner cavity 511.

The driving rod 530 is disposed in the inner cavity 511, and the massage head 520 is connected to the end of the driving rod 530, and at the same time, the massage head 520 is located in the opening 512.

The driving rod 530 reciprocates and drives the massage head 520 to reciprocate in the opening 512, so that the massage head 520 is used to repeatedly hit the human body to massage the human muscles.

A heat dissipation channel 600 is formed at the opening 512.

The external air of the body 510 is drawn into the inner cavity 511 from the heat dissipation channel 600 by the reciprocating of the driving rod 530, and discharged from the channel 600 through the reciprocating of the driving rod 530, thereby realize the circulation of airflow to achieve the function of ventilation and heat dissipation of the components arranged in the inner cavity 511 of the massage body 510.

In practice, most fitness people will massage the muscle groups by massager after strenuous exercise. At this time, a lot of sweat will remain on the user's body surface and palm area. According to the present invention, the heat dissipation channel 600 is provided at the front end of the body 510, which can prevent sweat from entering the massager through the heat dissipation holes, and contaminating the electronic components such as the motor, coil and control board arranged in the massager, and avoid short circuit, burnout, etc. and at the same time eliminate potential safety hazards.

Can prevent sweat from entering the massager through the heat dissipation holes, contaminate the electronic components such as the motor, coil, and control board inside the massager, avoid short circuit, burnout and other failures, and eliminate potential safety hazards.

In a specific implementation, the driving rod 530 is provided with a power-assisted suction and exhaust structure which can improve the suction and exhaust efficiency of the drive rod 530, the flow speed of the airflow in the heat dissipation channel 600 and inner cavity 511, and the heat dissipation effect.

In practice, there are various implementations that can support the function of the power-assisted suction and exhaust structure, which are described as follows.

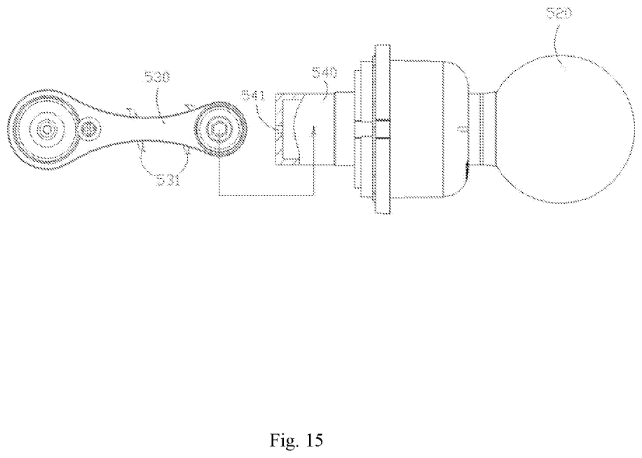

As shown in FIG. 15, the power-assisted suction and exhaust structure may be a plurality of fan blades 531 which are divided into suction fan blades and exhaust fan blades. When the driving rod 530 moves inward and drives the massage head 520 to move inward, the suction fan blades can improve the suction efficiency of the driving rod 530. When the driving rod 530 moves outward and drives the massage head 520 to move outward, the exhaust fan blade can improve the exhaust efficiency of the driving rod 530.

The power-assisted suction and exhaust structure may also be a fin, a blade, a lug, a convex plate, and so on.

The power-assisted suction and exhaust structure may also be an airflow groove, a hole and the like.

In a specific implementation, the driving rod 530 reciprocates back and forth in the inner cavity 511.

In a specific implementation, the driving rod 530 is driven to reciprocate by the motor 550, and also can be driven by other devices, such as an air pressure, a hydraulic cylinder, and so on.

In a specific implementation, the battery, the control circuit board and other components are simultaneously arranged in the inner cavity 511.

In a specific implementation, there are various embodiments that can form the heat dissipation channel 600, as shown in FIGS. 11 to 14.

As shown in FIG. 15, in a specific implementation, a sleeve 540 is connected to the front end of the driving rod 530, and the massage head 520 is detachably inserted into the sleeve 540. When in use, different massages head 520 can be selected according to needs and be inserted into the sleeve 540 to achieve different massage effects. The sleeve 540 is provided with an exhaust hole 541. When the massage head 520 is inserted into the sleeve 540, the air in the sleeve 540 can be discharged through the exhaust hole 541 to facilitate the installation and removal of the massage head 520.

1: A hand-held muscle massager , comprising a massage body (10), a massage head (20), a main handle (30) and an auxiliary handle (40), wherein the massage body (10) is provided with a massage head assembling end (11) and a handle connecting end (12) , the massage head (20) is assembled in the massage head assembling end (11), while the main handle (30) and the auxiliary handle (40) are simultaneously connected to the handle connecting end (12) , the massage body (10), the main handle (30) and the auxiliary handle (40) are connected to form an integral body, a smooth pressing grip surface (50) is formed at the joint of the massage body (10), the main handle (30) and the auxiliary handle (40), and a user can hold the smooth pressing grip surface (50) to perform pressing massage.

2: A hand-held muscle massager according to claim 1, wherein the hand-held muscle massager further comprises a driving motor (110), a piston-type moving head (120) and a connecting rod assembly (130) , the massage body (10) has a body inner cavity (61) which is provided with a motion opening (62) , the main handle (30) is provided with a main handle inner cavity (63), and the auxiliary handle (40) is provided with a auxiliary handle inner cavity (64), the body inner cavity (61), the main handle inner cavity (63) and the auxiliary handle inner cavity (64) are communicated with each other to form a ventilation and heat dissipation passage,
the driving motor (110), the piston-type moving head (120) and the connecting rod assembly (130) are simultaneously arranged in the ventilation and heat dissipation passage, the massage head (20) is assembled on the piston-type moving head (120) which is arranged in the motion opening (62),
the connecting rod assembly (130) is connected between the driving motor (110) and the piston-type moving head (120), and the driving motor (110) drives the piston-type moving head (120) to reciprocate in the motion opening (62) through the connecting rod assembly (130),
the reciprocating of the piston-type moving head (120) draws external air into the ventilation and heat dissipation passage from the motion opening (62), and then the external air is pumped out of the ventilation and heat dissipation passage by means of the reciprocating movement of the piston-type moving head (120) after absorbing heat in the ventilation and heat dissipation passage.

3: A hand-held muscle massager according to claim 2, wherein further comprises a battery (140) which is also disposed in the ventilation and heat dissipation passage.

4: A hand-held muscle massager according to claim 2, wherein the motion opening (62) is both the air inlet and the air outlet of the ventilation and heat dissipation passage, the external air is drawn into the ventilation and heat dissipation passage from the motion opening (62), and then pumped out by means of the reciprocating movement of the piston-type moving head (120) after absorbing heat in the ventilation and heat dissipation passage.

5: A hand-held muscle massager according to claim 2, wherein a self-adaptive adjustment structure gap (200) is provided at the connection position of the connecting rod assembly (130) and the piston-type moving head (120)),
when the driving motor (110) drives the piston-type moving head (120) to move through the connecting rod assembly (130), first, the driving motor (110) drives the connecting rod assembly (130) to move, and at the same time, the connecting rod assembly (130) drives the piston-type moving head (120) to move, at this moment, the driving force acted on the piston type moving head (120) by the connecting rod assembly (130) automatically adjusts the self-adaptive adjustment gap (200), so that the connecting rod assembly (130) and the piston-type moving head (120) can adjust the connection position by means of the driving force.

6: A hand-held muscle massager according to claim 5, wherein a cam (112) is sleeved on the output shaft of the driving motor (110), and the connecting rod assembly (130) is a rigid connecting rod, one end of the rigid connecting rod is fixedly locked on the cam (112), and the other end is pivotally connected in the piston-type moving head (120) , the self-adaptive adjustment structure gap (200) is located at the pivotally connecting position of the rigid connecting rod and the piston-type moving head (120),
the piston-type moving head (120) is provided with a pivot connection groove (121) at one end, the rigid connecting rod is inserted into the pivot connection groove (121), and the pivot bolt (122) pivotally connects the rigid connecting rod to the pivot connection groove (121),
the self-adaptive adjustment structure gap (200) is simultaneously located between the top surfaces of the rigid connecting rod and the pivot connection groove (121), and between the bottom surfaces of the rigid connecting rod and the pivot connection groove (121).

7: A hand-held muscle massager according to claim 2, wherein the massage head (20) is assembled on the piston-type moving head(120) through a detachable connection unit (300),
the detachable connection unit (300) comprises a plug (310) which the massage head (20) is detachably assembled on, wherein the massage head (20) comprises a detachable groove (311), and the plug (310) is provided with several snap rings (312),
when the plug (310) is inserted into the detachable groove (311), the longitudinal relative position of the massage head (20) and the plug (310) are fixed by means of the snap rings (312),
along the longitudinal direction of the plug (310), a positioning groove (313) is recessed on the outer surface of the plug (310), and the horizontal relative position of the massage head (20) and the plug (310) can be fixed by means of the positioning groove (313), so that the massage head (20) can not rotate on the plug (310).

8: A hand-held muscle massager comprising a body (510), a massage head (520) and a driving rod (530), wherein,
the body (510) has an inner cavity (511) and an opening (512) which is communicated and disposed at one end of the inner cavity (511), the driving rod (530) is disposed in the inner cavity (511), the massage head (520) is connected to the end of the driving rod (530), while the massage head (520) is located in the opening (512), the driving rod (530) reciprocates and drives the massage head (520) to reciprocate in the opening (512), thus a heat dissipation channel (600) is formed at the opening (512),
the external air of the body (510) is sucked into the inner cavity (511) from the heat dissipation channel (600) by the reciprocating of the driving rod (530), and then discharged from the channel (600)by the reciprocating of the driving rod (530).

9: A hand-held muscle massager according to claim 8, wherein the driving rod (530) is provided with a power suction and exhaust structure.

10: A hand-held muscle massager according to claim 8, wherein a sleeve (540) is connected to the front end of the driving rod (530), and the massage head (520) is detachably inserted into the sleeve (540) provided with an exhaust hole (541).
